(19) United States
(12) Patent Application Publication
(10) Pub. No.: US 2005/0039594 A1
(43) Pub. Date: Feb. 24, 2005

(54) Method and device for imparting distortion effect to signal from stringed instrument

(76) Inventor: Scott P. Dubal, Hillsboro, OR (US)

Correspondence Address: INTEL CORPORATION, P.O. BOX 5326, SANTA CLARA, CA, 95056-5326, US

(21) Appl. No.: 10/645,002

(22) Filed: Aug. 20, 2003

(51) Int. Cl. G10H 1/02

(52) U.S. Cl. 84/737

(57) ABSTRACT

Disclosed is a device and system to impart a distortion effect to a digital audio signal generated in response to vibrations of a strings of a stringed musical instrument. A communication adapter may transmit the digital audio signal in data frames over a transmission medium coupled to the musical instrument. One or more bits in at least some of the data frames may be modified to impart the distortion effect to the digital audio signal.

### BACKGROUND

1. Field

The subject matter disclosed herein relates to stringed musical instruments. In particular, the subject matter disclosed herein relates to stringed musical instruments which are attachable to amplification equipment by a cable.

2. Information

Since the 1950s, electric guitars and other electric stringed instruments have become common place in popular music. In an electric stringed instrument such as an electric guitar, one or more transducer pickups are typically disposed close to strings to generate an electric signal in response to vibrations of the strings. The electric signal may then be transmitted to an amplifier to amplify the signal through speakers.

Prior to the wide use of solid state electronics, musicians typically used amplifiers employing vacuum tubes to amplify tones generated from electric stringed instruments. Such vacuum tube amplifiers typically produced harmonic distortion in the amplified signal that has been used by electric guitarists to produce a “warm” or “vintage” sound. While the evolution of solid state electronics has enabled lower cost and more reliable amplification equipment for electrical stringed instruments, musicians have employed various devices to recreate the vintage sound of vacuum tube amplifiers with the use of distortion pedals, etc. In addition, some electric guitars sold by Danelectro include a feature to add distortion to signals prior to being transmitted from the electric guitar by selecting a setting on an external control.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows an electric stringed instrument according to an embodiment of the present invention.

FIG. 2 shows a schematic diagram of a system to impart a distortion effect to a digital signal according to an embodiment of the electric stringed instrument shown in FIG. 1.

FIG. 3 shows a schematic diagram of a cable adapter and distortion device according to an embodiment of the system shown in FIG. 2.

FIG. 4 shows a diagram illustrating a format of a data frame for transmitting an audio signal according to an embodiment of the cable adapter shown in FIG. 3.

FIG. 5 shows a diagram of a format of a media payload portion of a data frame according to an embodiment of the data frame illustrated in FIG. 4.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Machine-readable medium” as referred to herein relates to media capable of maintaining expressions which are perceivable by one or more machines. For example, a machine readable medium may comprise one or more storage devices for storing machine-readable instructions or data. Such storage devices may comprise storage media such as, for example, optical, magnetic or semiconductor storage media. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments of the present invention are not limited in this respect.

A “stringed instrument” as referred to herein relates to a musical instrument that generates tones in response to the striking of strings. For example, based upon a length, tension or other physical properties of a string on a stringed instrument, vibrations of the string may generate tones or notes. However, this is merely an example of a stringed instrument and embodiments of the present invention are not limited in this respect.

A “pickup” as referred to herein relates to a device coupled to a stringed instrument to detect the vibrations of one or more strings. A pickup may comprise one or more electrical transducers to generate an electric signal in response to acoustical vibrations generated by the string. For example, a pickup may generate an electrical signal which is representative of a tone or intensity of a vibration generated by a string. However, this is merely an example of a pickup and embodiments of the present invention are not limited in this respect.

A “digital signal” as referred to herein relates to a signal represented as a series of numerical values. For example, a digital signal may be generated by sampling an analog signal at discrete sample intervals such that the digital signal comprises a series of sampled values. However, this is merely an example of a digital signal and embodiments of the present invention are not limited in this respect.

A “distortion effect” as referred to herein relates to an effect that may be imparted to an audio signal. For example, a signal representative of a tone or vibration from a musical instrument may be modified such that the digital signal, when amplified through a speaker, deviates from the tone or vibration generated by the musical instrument absent the distortion effect. Such a distortion effect may impart harmonics to an otherwise “clean” audio signal and cause notes to sustain. For example, a distortion effect imparted to an audio signal generated by an electric guitar or other stringed instrument may emulate the use of “vintage” amplification systems that generate desired harmonic distortion from vacuum tube amplification systems. However, these are merely examples of a distortion effect that may be imparted to an audio signal and embodiments of the present invention are not limited in these respects.

“Data frames” or “frames” as referred to herein relates to a segment of data which is formatted for transmission from a source to a destination. A data frame may comprise a header portion and a payload portion. A data frame may be formatted as an “Ethernet frame” for transmission in a data link according to any one of several Ethernet data transmission protocols such as 10Base-T, 100Base-T or 1000Base-T. However, these are merely examples of a data frame and embodiments of the present invention are not limited in these respects.

A “communication adapter” as referred to herein relates to a device that is capable of transmitting data between an apparatus and a data transmission medium such as, for example, a cable or a wireless transmission medium. A communication adapter may comprise a “frame buffer” that may store data in data frames for transmission in a transmission medium according to a data link protocol. However, this is merely an example of a communication adapter and embodiments of the present invention are not limited in these respects.

A “cable adapter” as referred to herein relates to a communication adapter that is capable of transmitting power and/or data between a cable attached to the adapter and another device hosting the cable adapter. For example, a cable adapter may be coupled as an endpoint of a data link coupling the host device with another device on an opposite end of a cable. However, this is merely an example of a cable adapter and embodiments of the present invention are not limited in these respects.

A “bit” or “bits” as referred to herein relates to a representation of data. For example, a bit may represent a binary value such as a “one” or a “zero.” Alternatively, such a bit may represent a boolean value such as “true” or “false.” However, these are merely examples of a bit and embodiments of the present invention are not limited in these respects.

An “audio slot” as referred to herein relates to a portion of a data frame that is formatted to contain data that is representative of an audio signal. For example, an audio slot may be used to transmit a digital audio signal to a destination. However, this is merely an example of an audio slot and embodiments of the present invention are not limited in these respects.

Briefly, embodiments of the present invention relate to imparting a distortion effect to one or more digital audio signals generated in response to vibrations of a strings of a stringed musical instrument. A communication adapter may transmit the one or more digital audio signal in data frames over a transmission medium coupled to the musical instrument. One or more bits in at least some of the data frames may be modified to impart the distortion effect to the digital audio signal. However, this is merely an example embodiment and other embodiments of the present invention are not limited in these respects.

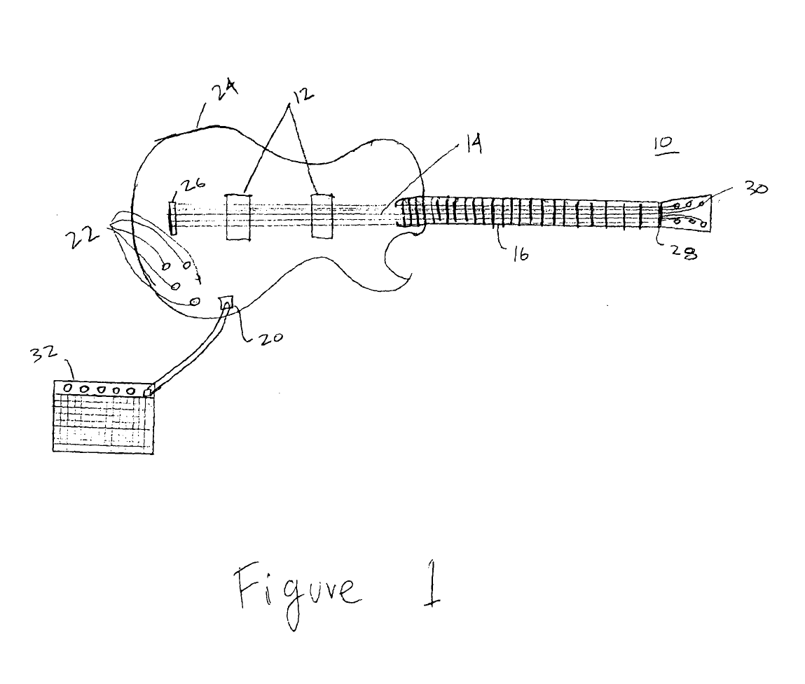

FIG. 1 shows an electric stringed instrument 10 according to an embodiment of the present invention. The stringed instrument may be an electric guitar. However, embodiments of the present invention are also applicable to other types of stringed instruments capable of generating an audio signal in response to string vibrations. The stringed instrument 10 comprises a plurality of strings 14 stretched between a bridge 26 and a nut 28. Pegs 30 may be used to tightened or loosen the strings 14 to maintain proper pitch. Disposed underneath the strings 14 are pickups 12 which may generate an audio signal in response to vibrations of the strings 14 (e.g., from strumming, picking or bowing). Pickups 12 may comprise dual coil pickups such as those employed in stock versions of the Gibson Les Paul® electric guitar or single coil pickups such as those employed in stock versions of the Fender Stratocaster® electric guitar. In other embodiments, a transducer embedded in an acoustic or semi-acoustic stringed instrument may be used to generate an audio signal in response to string vibrations. However, these are merely examples of how an electric audio signal may be generated in response to vibrations of strings on a stringed instrument and embodiments of the present invention are not limited in these respects.

The stringed instrument 10 may comprise an adapter 20 adapted to be coupled to a cable 30 to transmit an audio signal to an amplifier 32. In one embodiment, the cable 30 may comprise an unshielded twisted pair transmission medium such as category 5 cabling and the adapter 20 may transmit the audio signal as digital data in Ethernet frames according to a 100Base-T protocol as described in the Media-accelerated Global Information Carrier Engineering Specification, Rev. 3.0c, May 2003 (hereinafter “the MaGIC specification”). In some embodiments, the adapter 20 may draw electrical power from the cable 30 to power electronics in the stringed instrument 10 using techniques proposed by the IEEE 802.3af working group. In alternative embodiments, the adapter 20 may transmit data frames containing the digital audio signal to an amplifier in a wireless data transmission medium. Upon receipt of the data frames, the amplifier 32 may convert the digital audio signal to an analog signal and amplify the analog signal through a speaker.

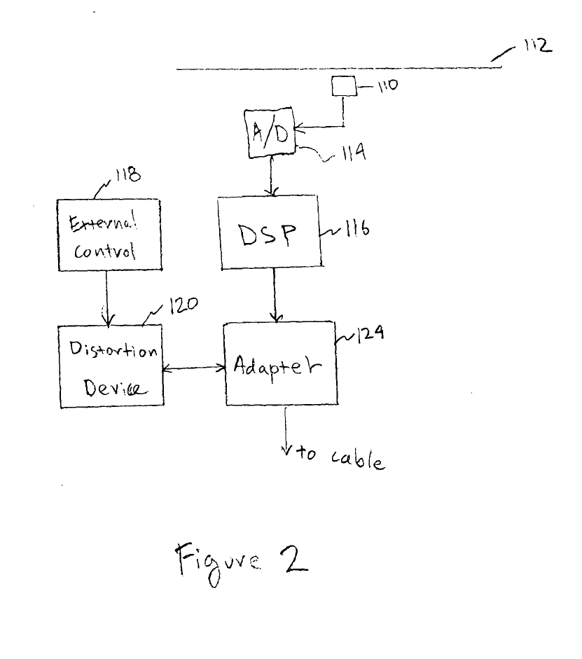

FIG. 2 shows a schematic diagram of a system 100 in a stringed instrument to impart a distortion effect to a digital signal according to an embodiment of the electric stringed instrument shown in FIG. 1. In response to vibrations of a string 112, a pickup 110 may transmit an analog signal representative of the tone and intensity of the vibrations to an analog to digital (A/D) converter 114. The AID converter 114 may sample the analog signal and provide the sampled output to a digital signal processor 116. The digital signal processor may condition the sampled output signal (e.g., using digital filtering or equalization techniques) to provide a digital audio signal to an adapter 124.

The adapter 124 may format the digital audio signal into data frames for transmission in a cable (not shown) according to a data transmission protocol such as Ethernet (e.g., 100Base-T). However, again, in alternative embodiments the adapter 124 may transmit the digital audio signal in data frames over a wireless data transmission medium. Upon receipt of the digital audio signal at the adapter 124, a distortion device 120 may modify or manipulate one or more portions of the audio signal to impart a distortion effect to the audio signal when it is reproduced and amplified (e.g., at the amplifier 32). A distortion control 118 may determine a degree of distortion to be imparted to the digital audio signal based upon a setting (e.g., a setting of a control 22 on the stringed instrument 10 shown in FIG. 1).

While FIG. 2 shows the distortion device 120 being directly coupled to the adapter to impart a distortion effect to a digital audio signal received in the adapter 124, in other embodiments a distortion device may be coupled to the digital signal processor 116 to impart a distortion effect to the digital audio signal before being received in the adapter 124. In other embodiments, the digital signal processor 116 may internally comprise logic to impart a distortion effect to the digital audio signal independently of a distinct distortion device. In other embodiments, analog signals from multiple pickups may be multiplexed and provided to the A/D 114 converter for generating a sampled output. Further, for embodiments with multiple pickups, the analog signal output of each pickup may be individually sampled by an A/D converter and then digitally processed by a dedicated digital signal processor.

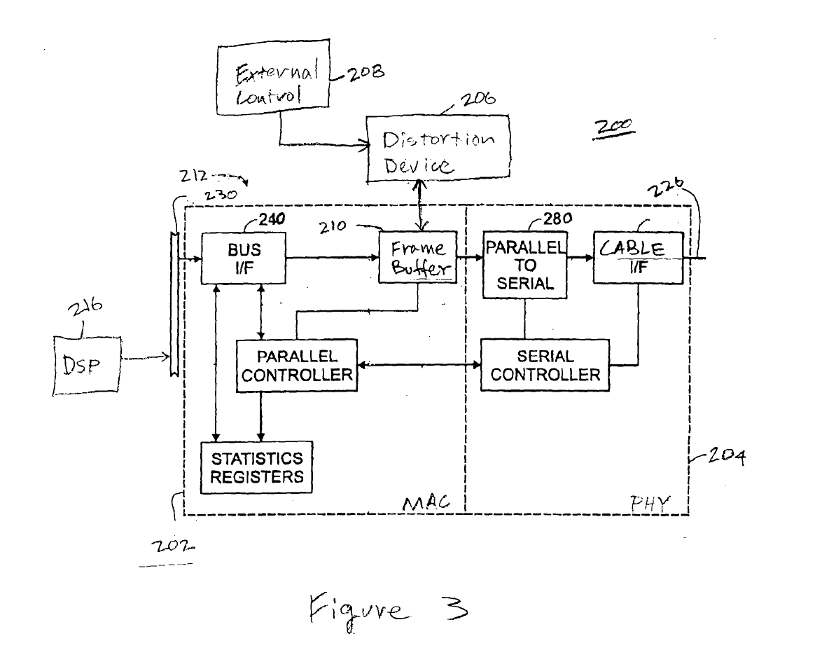

FIG. 3 shows a schematic diagram of a cable adapter 212 and distortion device 206 according to an embodiment of the system 100 shown in FIG. 2. The adapter 212 comprises a media access controller (MAC) 202 and a physical layer transmission device (phy) 204. The MAC 202 may be coupled to a digital signal processor 216 by a data bus 230 to receive a digital audio signal. The data bus 230 may comprise any one of several bus structures for transmitting data between devices such as, for example, a bus structure according to versions of the Peripheral Components Interconnect or Hypertransport interconnect specification. However, this is merely an example of how a digital signal processor may be coupled to a MAC to provide a digital audio signal and embodiments of the present invention are not limited in this respect.

According to an embodiment, the digital audio signal received from the digital signal processor 216 may be formatted into data frames in a frame buffer 210. The frame buffer 210 may store one or more data frames for transmission through a cable 226 coupled to a cable interface 232. The cable interface may comprise fittings for electrically coupling the adapter 212 to the cable 226 such as, for example, an RJ-45 compatible socket (not shown). Data frames in the frame buffer may be transmitted through the cable interface 232 on a first-in first-out basis. In alternative embodiments, instead of the cable interface 232, the adapter 212 may comprise circuitry for transmitting the data frames in a wireless transmission medium.

The frame buffer 210 may comprise one or more a dual port memory devices to receive digital audio signal from the digital signal processor 216 and allow a distortion device 206 to access data frames stored in the frame buffer 210. In response to a setting from an external control 208, the distortion device 206 may modify portions of a digital audio signal formatted in the data frames stored in the frame buffer 210. For example, the distortion device 206 may identify which data frames contain a digital audio signal. If a data frame contains a digital audio signal, the distortion device may modify portions of the digital audio signal stored in the data frame.

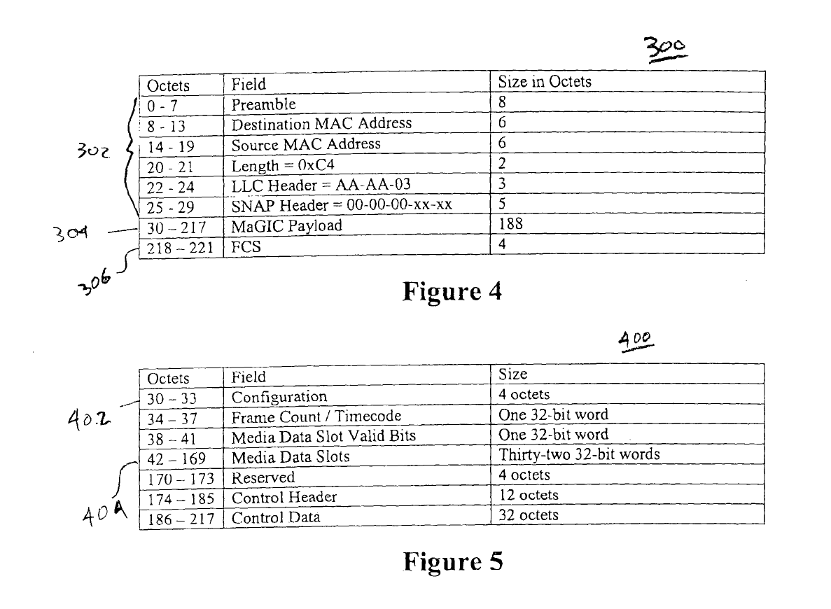

FIG. 4 shows a diagram illustrating a format of a data frame 300 for transmitting a digital audio signal according to an embodiment of the cable adapter 212 shown in FIG. 3. Data frames formatted according to the format of data frame 300 may be transmitted from the frame buffer 210 through the cable interface 232. In the illustrated embodiment, the data frame comprises a plurality of fields including an Ethernet frame header 302, payload 304 and frame check sequence 306. The payload portion 304 may comprise a digital audio signal formatted according to a MaGIC payload as described in section 6 of the MaGIC specification.

FIG. 5 shows a diagram of a format of a media payload portion 400 of a data frame according to an embodiment of the data frame illustrated in FIG. 4. The media payload portion 400 comprises a plurality of fields including a Configuration Field 402 and Media Data Slots field 402. The Configuration field 402 may indicate the presence of a digital audio signal in the Media Data Slots field 402 and the Media Data Slots field may contain a digital audio signal received from the digital signal processor 216 (FIG. 3) in fixed sized “audio slots.” Accordingly, the distortion device 206 (FIG. 3) may identify data frames in the frame buffer 210 which are carrying a digital audio signal by examining the contents of the Configuration field 402 of each data frame.

Upon detecting the presence of a digital audio signal in a data frame stored in the frame buffer 210, the distortion device 206 may manipulate portions of the data in the audio slots to impart an effect (e.g., distortion effect) to the digital audio signal when converted to an analog signal and amplified through a speaker. For example, the distortion device 206 may impart a degree of harmonic distortion to the digital audio signal. However, this is merely an example of an effect that may be imparted to a digital audio signal by a distortion device and embodiments of the present invention are not limited in this respect.

To impart a distortion effect to the digital audio signal in a data frame, according to one embodiment, a number of “dirty bits” from the audio slots may be selected based upon a desired degree of distortion (e.g., based upon a setting from an external control 208). The portions the dirty bits may be randomly selected from locations in the audio slots for replacement with a predetermined or random bit pattern. In another embodiment, the distortion device 206 may retrieve portions of a digital audio signal from the data frame as stored in the frame buffer 210, manipulate or modify portions of the retrieved digital audio signal and then write the manipulated or modified portions in the same location in the frame buffer 210. The digital audio signal may be modified emulate the presence of harmonic distortion. For example, the distortion device 206 may extract a waveform from the digital audio signal in one or more audio slots, digitally add harmonics to the digital audio signal and write the combined digital signal back to the audio slots using techniques known to those of ordinary skill in the art of digital music signal processing. Again, the degree of harmonic distortion may be determined based upon a setting of the external control 208. It should be understood, however, these are merely examples of techniques that may be used to impart a distortion effect to a digital audio signal and embodiments of the present invention are not limited in these respects.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

1. A stringed instrument comprising:
one or more pickups to generate one or more electrical signals in response to string vibrations;
one or more digital signal processors to generate at least one digital signal based upon the one or more electrical signals;
a communication adapter to transmit the at least one digital signal in a transmission medium in data frames, each data frame comprising a plurality of bits to represent a portion of the at least one digital signal; and
a distortion device to manipulate at least a portion of the one or more digital signals to impart a distortion effect.

2. The stringed instrument of claim 1, wherein communication adapter comprises a frame buffer to receive the at least one digital signal from the one or more digital signal processors and the distortion device manipulates bits in at least some of the data frames in the frame buffer.

3. The stringed instrument of claim 2, wherein the distortion device further comprises:
logic to detect the presence of a data frame containing a portion of the digital signal in the frame buffer; and
logic to modify an audio slot portion of at least some of the detected data frames.

4. The stringed instrument of claim 1, wherein the distortion device is coupled to the one or more digital signal processors to manipulate portions of the at least one digital signal.

5. The stringed instrument of claim 1, wherein the distortion device is disposed within logic controlled by the one or more digital signal processors.

6. The stringed instrument of claim 1, the stringed instrument further comprising an external control to select a degree of the distortion effect to be imparted to the at least one digital signal.

7. The stringed instrument of claim 6, wherein the distortion device comprises logic to modify a number of bits in each of the at least some of the data frames based upon a setting of the external control.

8. The stringed instrument of claim 1, wherein the distortion effect comprises adding harmonic distortion to the one or more digital signals.

9. The stringed instrument of claim 1, wherein the distortion effect comprises a replacement of at least a portion of the one or more digital signal with a random bit pattern.

10. The stringed instrument of claim 1, wherein the distortion effect comprises a replacement of at least a portion of the one or more digital signals with a predetermined bit pattern.

11. The stringed instrument of claim 1, wherein the communication adapter comprises a physical layer communication device to transmit data frames according to a 100Base-T protocol.

12. The stringed instrument of claim 11, wherein the communication adapter comprises circuitry to draw power from a twisted pair cable.

13. A method comprising:
receiving one or more electrical signals from one or more pickups coupled to a stringed instrument generated in response to string vibrations;
generating one or more digital signals based upon the one or more electrical signals;
manipulating at least a portion of the one or more digital signals to impart a distortion effect;
formatting the one or more digital signal into one or more data frames; and
transmitting the data frames in a transmission medium from the stringed instrument to a destination device, each data frame comprising a plurality of bits to represent a portion of the one or more digital signals.

14. The method of claim 13, the method further comprising:
storing the one or more data frames in a frame buffer; and
modifying bits in at least some of the data frames in the frame buffer to impart the distortion effect.

15. The method of claim 14, the method further comprising:
detecting the presence of a data frame containing a portion of the one or more digital signal in the frame buffer; and
modifying an audio slot portion of at least some of the detected data frames to impart the distortion effect.

16. The method of claim 13, the method further comprising:
modifying portions of the one or more digital signals under the control of one or more digital signal processors; and
providing a distorted digital signal to the frame buffer for transmission.

17. The method of claim 13, the method further comprising affecting a degree of the distortion effect to be imparted to the digital signal in response to a control coupled externally to the stringed instrument.

18. The method of claim 17, wherein modifying at least a portion of the one or more digital signals further comprises modifying a number of bits in each of the at least some of the data frames based upon a setting of the control.

19. The method of claim 13, wherein modifying at least a portion of the one or more digital signals further comprises adding harmonic distortion to the one or more digital signals.

20. The method of claim 13, wherein modifying at least a portion of the one or more digital signals further comprises replacing at least a portion of the one or more digital signal with a random bit pattern.

21. The method of claim 13, wherein modifying at least a portion of the one or more digital signals further comprises replacing at least a portion of the one or more digital signals with a predetermined bit pattern.

22. The method of claim 13, the method further comprising transmitting the data frames in the cable according to a 100Base-T protocol.

23. An apparatus comprising:
a communication adapter comprising a frame buffer to receive one or more digital audio signal to form data frames for transmission in a transmission medium; and
a distortion device to modify one or more bits in at least some of the data frames to impart a distortion effect to the one or more digital audio signals.

24. The apparatus of claim 23, wherein the distortion device further comprises:
logic to detect the presence of a data frame containing a portion of the one or more digital audio signals in the frame buffer; and
logic to modify an audio slot portion of at least some of the detected data frames.

25. The apparatus of claim 23, wherein the distortion device comprises logic to impart a degree of distortion to the digital audio signal based upon a setting of an external control.

26. The apparatus of claim 25, wherein the distortion device comprises logic to modify a set number of bits in at least some of the data frames based upon the degree of distortion to be imparted to the digital audio signal.

27. The apparatus of claim 23, wherein the distortion effect comprises an addition of harmonic distortion to the digital audio signal.

28. The apparatus of claim 23, wherein the distortion effect comprises a replacement of at least a portion of the one or more digital signal with a random bit pattern.

29. The apparatus of claim 23, wherein the distortion effect comprises a replacement of at least a portion of the one or more digital signals with a predetermined bit pattern.

30. The apparatus of claim 23, wherein the communication adapter further comprises a physical layer communication device to transmit data frames according to a 100Base-T protocol.

31. The apparatus of claim 30, wherein the communication adapter comprises circuitry to draw power from a twisted pair cable.
